(19) United States
(12) Patent Application Publication
(10) Pub. No.: US 2014/0067149 A1
(43) Pub. Date: Mar. 6, 2014

(54) COMPUTING DEVICE AND METHOD FOR DYNAMICALLY REGULATING SOLAR POWER

(71) Applicant: Hon Hai Precision Industry Co., Ltd, New Taipei (TW)

(72) Inventors: KAI-FU CHEN, New Taipei (TW); CHIA-YUN LEE, New Taipei (TW); CHIEN-SEN HSU, New Taipei (TW); CHUANG-WEI TSENG, New Taipei (TW)

(73) Assignee: HON HAI PRECISION INDUSTRY CO., LTD., New Taipei (TW)

(21) Appl. No.: 13/961,740

(22) Filed: Aug. 7, 2013

(30) Foreign Application Priority Data
Aug. 28, 2012 (TW) 101131153

(51) Int. Cl. H02J 5/00

(52) U.S. Cl. CPC H02J 5/00
USPC 700/295

(57) ABSTRACT

In a method for dynamically regulating solar power using a computing device, the computing device connects to one or more switches, and each of the switches connects to a load device. A first power of solar energy sourced from a solar cell is calculated according to a first voltage and a first current of the solar energy, and a second power of the solar energy according to the second voltage and the second current of the solar energy sourced from the solar cell. At least one load device is switched from a power supply to the solar cell through a switch if the first power is greater than the second power, and at least one load device is switched from the solar cell to the power supply through the switch if the first power is not greater than the second power.

### BACKGROUND

1. Technical Field

Embodiments of the present disclosure relate to power management systems and methods, and particularly to a computing device and a method for dynamically regulating solar power using the computing device.

2. Description of Related Art

Solar energy can be used to power electronic devices. However, given the characteristics of solar cells, it is difficult to maintain a relatively stable solar energy output from the solar cells. It is well known in the art that overdraw of power from the solar cells by the electronic devices may cause a rapid decrease of output power of the solar cells. Therefore, it is desirable to have a power regulating system and method that enables solar cells to deliver an optimized and stable output power to the electronic devices.

### BRIEF DESCRIPTION OF THE DRAWINGS

FIG. 1 is a block diagram of one embodiment of a computing device including a solar power regulating system.

FIG. 2 is a flowchart of one embodiment of a method for dynamically regulating solar power using the computing device of FIG. 1.

FIG. 3 shows a diagram illustrating voltages and currents of solar energy sourced from a solar cell.

FIG. 4 shows a diagram illustrating changes of output power of the solar energy sourced from the solar cell.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of a non-transitory computer-readable medium include CDs, DVDs, flash memory, and hard disk drives.

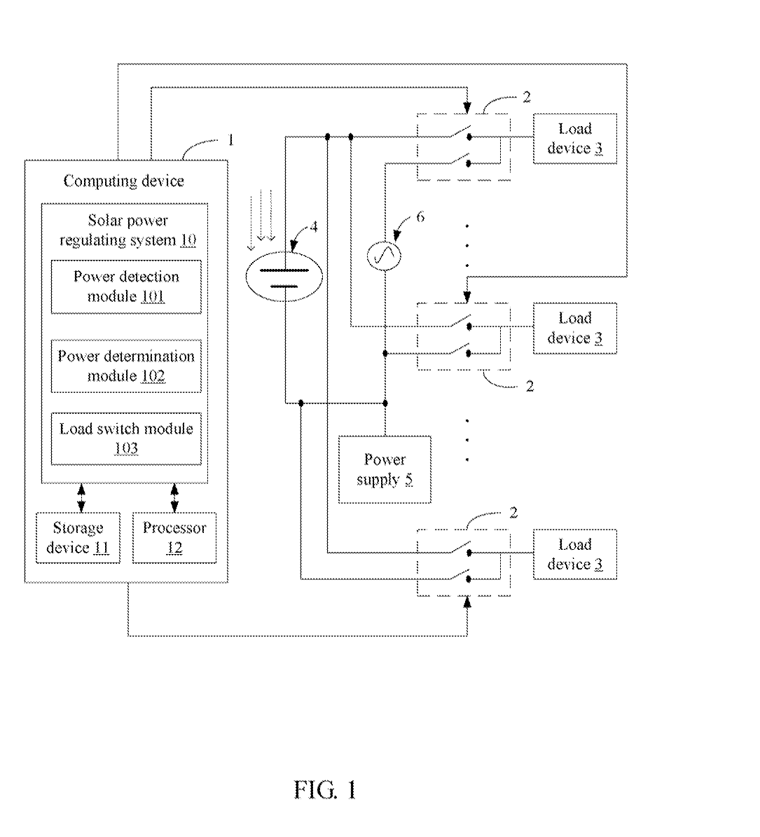

FIG. 1 is a block diagram of one embodiment of a computing device 1 including a solar power regulating system 10. In the embodiment, the solar power regulating system 10 is implemented by the computing device 1, and regulates solar energy drawn from a solar cell 4, to maintain a stable power output to load devices 3. In one embodiment, the computing device 1 may be a host computer, a server or any other data processing device.

The computing device 1 may further include, but is not limited to, a storage device 11 and at least one processor 12. In one embodiment, the storage device 11 may be an internal storage system, such as a random access memory (RAM) for temporary storage of information, and/or a read only memory (ROM) for permanent storage of information. The storage device 11 may also be an external storage system, such as an external hard disk, a storage card, network access storage (NAS), or a data storage medium. The processor 12 is a central processing unit (CPU) or microprocessor that performs various functions of the computing device 1.

In the embodiment, the computing device 1 connects to a plurality of switches 2, and each of the switches 2 connects to a load device 3. Each load device 3 can be connected to the solar cell 4 through a switch 2, or alternatively can be connected to a power supply 5. The load device 3 may be a personal computer, a notebook, a PDA device, an electronic machine, or other electronic devices.

Each of the switches 2 switches at least one load device 3 from being connected to the solar cell 4 to being connected to the power supply 5 when the output power of solar energy delivered from the solar cell 4 decreases, and switches at least one load device 3 from the power supply 5 to the solar cell 4 when the output power of solar energy delivered from the solar cell 4 increases. As such, the solar power regulating system 10 can enable the solar cell 4 to output an optimized and stable power to the load devices 3.

The solar cell 4 (also called a photovoltaic cell panel) is an electrical device that converts electrical power of solar light into electricity by the photovoltaic effect, and provides the electrical power to the load devices 3. The power supply 5 is a power source device that can provide electrical power to the load devices 3 directly. That is, each of the load devices 3 can be powered either by the solar cell 4 or by the power supply 5.

In the embodiment, each of the switches 2 connects to the solar cell 4 or the power supply 5 through a power convertor 6. The power convertor 6 can convert an alternating current (AC) sourced from the solar cell 4 or the power supply 5 into a direct current (DC) if the load device 3 is adapted to DC, or convert the DC sourced from the solar cell 4 or the power supply 5 to AC if the load device 3 is adapted to AC.

In one embodiment, the solar power regulating system 10 includes a power detection module 101, a power determination module 102, and a load switch module 103. The modules 101-103 may comprise computerized instructions in the form of one or more software programs that are stored in a non-transitory computer-readable media (e.g., the storage device 11) and executed by the at least one processor 12. A description of each module is given in the following paragraphs.

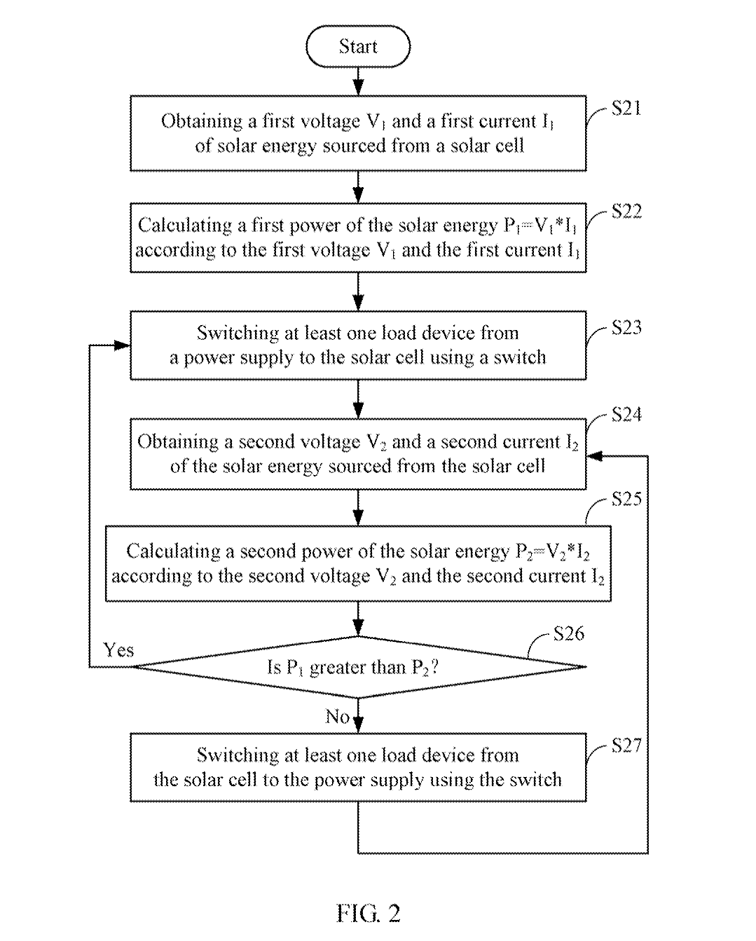

FIG. 2 is a flowchart of one embodiment of a method for dynamically regulating solar power using the computing device 1 of FIG. 1. The method is performed by execution of computer-readable software program codes or instructions by the at least one processor 12 of the computing device 1. The method enables the solar cell 4 to output optimized and stable power of the solar energy to the load devices 3. Depending on the embodiment, additional steps may be added, others removed, and the ordering of the steps may be changed.

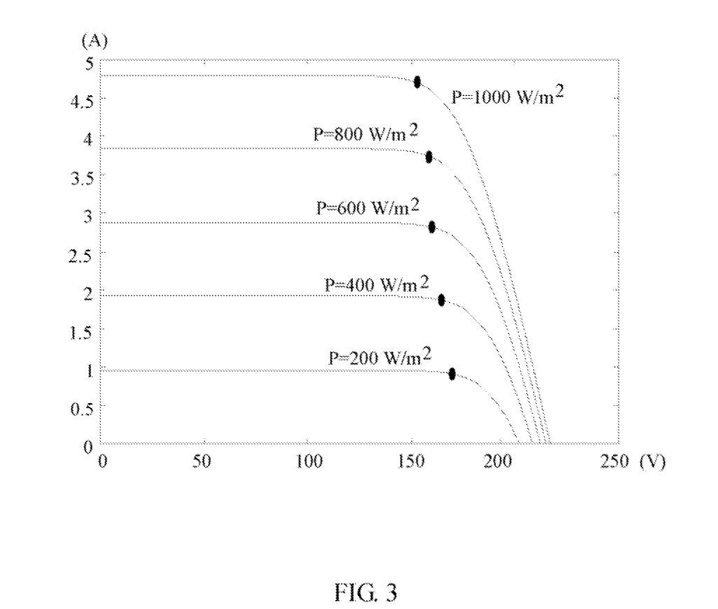

In step S21, the power detection module 101 obtains a first voltage V₁ and a first current I₁ of solar energy sourced from the solar cell 4. FIG. 3 shows a diagram illustrating voltages and currents of the solar energy sourced from the solar cell 4. The power detection module 101 detects the first voltage V₁ and the first current I₁ of the solar power at different time periods. For example, in one instant, the first voltage V₁=200 v and the first current I₁=5 A are output from the solar cell 4.

In step S22, the power detection module 101 calculates a first power P₁ of the solar energy according to the first voltage V₁ and the first current I₁, i.e., the first power P₁=V₁*I₁. Referring to FIG. 3, if the first voltage V₁=200 v and the first current I₁=5 A, the first power of the solar energy P₁=V₁*I₁=1000 W.

In step S23, the load switch module 103 switches at least one load device 3 from the power supply 5 to the solar cell 4 through the corresponding switch 2. In one embodiment, if the total number of the load devices 3 connected to the solar cell 4 increases, the output power of the solar energy sourced from the solar cell 4 decreases.

In step S24, the power determination module 102 obtains a second voltage V₂ and a second current I₂ of the solar energy sourced from the solar cell 4 at a time interval, such as one or two hours. Referring to FIG. 3, when the total number of the load devices 3 connected to the solar cell 4 changes, the available voltage and the current of the solar energy changes. For example, if a second load device 3 is further added to connect to the solar cell 4, the second voltage V₂=200 v and the second current I₂=4 A may be available as the power output from the solar cell 4.

In step S25, the power determination module 102 calculates a second power P₂ of the solar energy according to the second voltage V₂ and the second current I₂, i.e., the second power P₂=V₂*I₂. Referring to FIG. 3, if the second voltage V₂=200 v and the second current I₂=4 A, the second power of the solar energy P₂=V₂*I₂=800 W.

In step S26, the power determination module 102 determines whether the first power of the solar energy P₁ is greater than the second power of the solar energy P₂. If the first power of the solar energy P₁ is greater than the second power of the solar energy P₂, the process goes back to step S23. Otherwise, if the first power of the solar energy P₁ is not greater than the second power of the solar energy P₂, step S27 is implemented.

In step S27, the load switch module 103 switches the at least one load device 3 from the solar cell 4 to the power supply 5 through the switch 2. In one embodiment, if the total number of the load devices 3 connected to the solar cell 4 decreases, the output power of the solar energy sourced from the solar cell 4 increases.

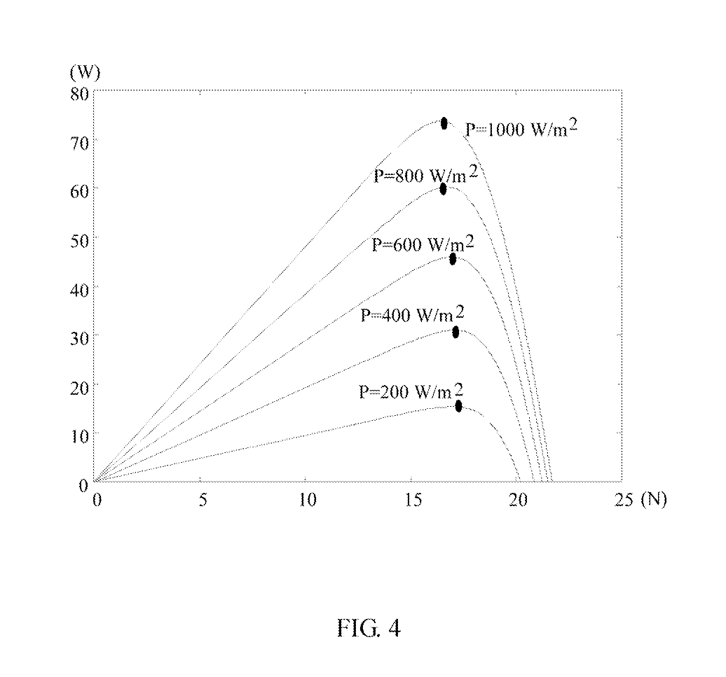

FIG. 4 shows a diagram illustrating changes of the output power of the solar energy sourced from the solar cell 4. The total number of the load devices 3 is represented by N, and the output power of the solar energy is presented by P. Five curves are shown in FIG. 4, and each of the curves represents a change of the output power of the solar energy. There is a maximum value in each of the curves, such as P=1000 W/m². After the maximum value of the power of the solar energy is outputted from the solar cell 4, the output power of the solar energy sourced from the solar cell 4 increases when the total number of the load devices 3 connected to the solar cell 4 decreases, and the output power of the solar energy sourced from the solar cell 4 decreases when the total number of the load devices 3 connected to the solar cell 4 increases.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device connected to a plurality of switches, each of the switches connected to a load device, the computing device comprising:
at least one processor; and
a storage device storing one or more computer-readable program instructions, which when executed by the at least one processor, causes the at least one processor to:
obtain a first voltage and a first current of solar energy sourced from a solar cell;
calculate a first power of the solar energy according to the first voltage and the first current;
obtain a second voltage and a second current of the solar energy sourced from the solar cell;
calculate a second power of the solar energy according to the second voltage and the second current;
determine whether the first power is greater than the second power;
switch at least one load device from a power supply to the solar cell through a corresponding switch if the first power is greater than the second power; and
switch at least one load device from the solar cell to the power supply through the corresponding switch if the first power is not greater than the second power.

2. The computing device according to claim 1, wherein the solar cell is converts energy of solar light into electrical power and provides the electrical power to the load devices, and the power supply is a power source device that provides the electrical power to the load devices directly.

3. The computing device according to claim 1, wherein output power of the solar energy sourced from the solar cell decreases when a total number of the load devices connected to the solar cell increases.

4. The computing device according to claim 1, wherein output power of the solar energy sourced from the solar cell increases when a total number of the load devices connected to the solar cell decreases.

5. The computing device according to claim 1, wherein each of the switches is connected to the solar cell or the power supply through a power convertor.

6. The computing device according to claim 5, wherein the power convertor converts an alternating current (AC) sourced from the solar cell or the power supply to a direct current (DC) if the at least one load device adapts to the DC, and converts the DC sourced from the solar cell or the power supply to the AC if the at least one load device adapts to the AC.

7. A method for dynamically regulating solar power using a computing device, the computing device connected to a plurality of switches, each of the switches connected to a load device, the method comprising:
obtaining a first voltage and a first current of solar energy sourced from a solar cell;
calculating a first power of the solar energy according to the first voltage and the first current;
obtaining a second voltage and a second current of the solar energy sourced from the solar cell;
calculating a second power of the solar energy according to the second voltage and the second current;
determining whether the first power is greater than the second power; and
switching at least one load device from a power supply to the solar cell through a corresponding switch if the first power is greater than the second power; or
switching at least one load device from the solar cell to the power supply through the corresponding switch if the first power is not greater than the second power.

8. The method according to claim 7, wherein the solar cell is an electrical device that converts energy of solar light into electrical power and provides the electrical power to the load devices, and the power supply is a power source device that provides the electrical power to the load devices directly.

9. The method according to claim 7, wherein output power of the solar energy sourced from the solar cell decreases when a total number of the load devices connected to the solar cell increases.

10. The method according to claim 7, wherein output power of the solar energy sourced from the solar cell increases when a total number of the load devices connected to the solar cell decreases.

11. The method according to claim 7, wherein each of the switches is connected to the solar cell or the power supply through a power convertor.

12. The method according to claim 11, wherein the power convertor converts an alternating current (AC) sourced from the solar cell or the power supply to a direct current (DC) if the at least one load device adapts to the DC, and converts the DC sourced from the solar cell or the power supply to the AC if the at least one load device adapts to the AC.

13. A non-transitory storage medium having stored thereon instructions that, when executed by at least one processor of a computing device, cause the processor to perform a method for dynamically regulating solar power, the computing device connected to a plurality of switches, each of the switches connected to a load device, the method comprising:
obtaining a first voltage and a first current of solar energy sourced from a solar cell;
calculating a first power of the solar energy according to the first voltage and the first current;
obtaining a second voltage and a second current of the solar energy sourced from the solar cell;
calculating a second power of the solar energy according to the second voltage and the second current;
determining whether the first power is greater than the second power;
switching at least one load device from a power supply to the solar cell through a corresponding switch if the first power is greater than the second power; and
switching at least one load device from the solar cell to the power supply through the corresponding switch if the first power is not greater than the second power.

14. The storage medium according to claim 13, wherein the solar cell is an electrical device that converts energy of solar light into electrical power and provides the electrical power to the load devices, and the power supply is a power source device that provides the electrical power to the load devices directly.

15. The storage medium according to claim 13, wherein output power of the solar energy sourced from the solar cell decreases when a total number of the load devices connected to the solar cell is increases.

16. The storage medium according to claim 13, wherein output power of the solar energy sourced from the solar cell increases when a total number of the load devices connected to the solar cell decreases.

17. The storage medium according to claim 13, wherein each of the switches is connected to the solar cell or the power supply through a power convertor.

18. The storage medium according to claim 17, wherein the power convertor converts an alternating current (AC) sourced from the solar cell or the power supply to a direct current (DC) if the at least one load device adapts to the DC, and converts the DC sourced from the solar cell or the power supply to the AC if the at least one load device adapts to the AC.
